(19) United States
(12) Patent Application Publication
(10) Pub. No.: US 2026/0064995 A1
(43) Pub. Date: Mar. 5, 2026

(54) METHOD AND APPARATUS FOR PROVIDING AN INTERFACE IN THE SAME LANGUAGE AS A LANGUAGE SET IN A USER DEVICE

(71) Applicants: HYUNDAI MOTOR COMPANY, Seoul (KR); KIA CORPORATION, Seoul (KR)

(72) Inventors: Bo Hyun Kim, Hwaseong-si (KR); Jae Min Joh, Hwaseong-si (KR)

(73) Assignees: HYUNDAI MOTOR COMPANY, Seoul (KR); KIA CORPORATION, Seoul (KR)

(21) Appl. No.: 19/029,927

(22) Filed: Jan. 17, 2025

(30) Foreign Application Priority Data
Aug. 27, 2024 (KR) 10-2024-0115373

(51) Int. Cl. G06F 40/58; G01C 21/36; G06F 40/242; G06F 40/263; G06V 30/24

(52) U.S. Cl. CPC G06F 40/58; G06F 40/242; G06F 40/263; G06V 30/24; G01C 21/3608

(57) ABSTRACT

A computer-implemented method and apparatus for providing an interface in a same language as a language set in a user device are provided. The method includes obtaining an utterance generated by the user for text provided to the user using the device and determining whether there is a command corresponding to the utterance among pre-stored commands. The method also includes determining whether a language of the text is the same as the language set in the device when it is determined that there is no command corresponding to the utterance. The method additionally includes providing updated text in the same language as the language set in the device to the user when it is determined that the language of the text is not the same as the language set in the device.

### CROSS-REFERENCE TO RELATED APPLICATION

The present application claims the benefit of and priority to Korean Patent Application No. 10-2024-0115373, filed on Aug. 27, 2024, in the Korean Intellectual Property Office, the entire contents of which are hereby incorporated herein by reference.

### TECHNICAL FIELD

The present disclosure relates to a method and apparatus for providing an interface in the same language as a language set in a user device.

### BACKGROUND

The statements in this section merely provide background information related to the present disclosure and do not necessarily constitute prior art.

A vehicle interface assists interaction between a driver/passenger and an Audio Video Navigation Telematics (AVNT) system of a vehicle such that users, for example, the driver and the passenger of the vehicle, can utilize various functions of the vehicle. In general, a vehicle interface provides content to drivers and passengers using the same language as the language used by the drivers and passengers for the convenience of the drivers and passengers. In other words, the default language of the vehicle interface is generally the same as the language used by the drivers and passengers.

However, conventional vehicle interfaces provide some content (e.g., content produced in a country other than the country where drivers and passengers reside) using a language different from the language used by the drivers and passengers. Accordingly, there is a limitation that the accuracy of interaction between a driver/passenger and an AVNT system of a vehicle is low.

### SUMMARY

Therefore, there is a need for a method and apparatus for improving the accuracy of interaction between a driver/passenger and an AVNT system of a vehicle by converting the language of content provided by a vehicle interface into the default language of the vehicle interface and providing the language when the language of content is different from the language used by the driver and passenger of the vehicle, i.e., the default language of the vehicle interface.

An object of the present disclosure is to provide a method and apparatus for providing an interface in the same language as a language set in a user device. Specifically, an object of the present disclosure is to provide a method and apparatus for providing an interface in the same language as a language set in a user device by determining whether pre-stored commands include a command corresponding to user utterance, determining whether a language of text provided to a user is the same as a language set in the device, updating the text in the same language as the language set in the device on the basis of the determination result, and providing the text to the user.

The technical objects of the present disclosure are not limited to those described above. Other technical objects not mentioned herein may be understood more clearly by those having ordinary skill in the art from the description below.

According to an embodiment of the present disclosure, a computer-impemented method of providing an interface in the same language as a language set in a device of a user is provided. The method includes obtaining an utterance generated by the user for text provided to the user using the device. The method also includes determining whether there is a command corresponding to the utterance among pre-stored commands. The method additionally includes determining whether a language of the text is the same as the language set in the device when it is determined that there is no command corresponding to the utterance. The method further includes providing updated text to the user when it is determined that the language of the text is not the same as the language set in the device. The updated text is in the same language as the language set in the device.

According to another embodiment of the present disclosure, an apparatus for providing an interface in the same language as a language set in a device of a user is provided. The apparatus cincludes at least one memory storing instructions and at least one processor. The instructions, when executed by the at least one processor, cause the at least one processor to: obtain an utterance generated by the user for text provided to the user using the device; determine whether there is a command corresponding to the utterance among pre-stored commands; determine whether a language of the text is the same as the language set in the device when it is determined that there is no command corresponding to the utterance; and provide updated text to the user in which the updated text is in the same language as the language set in the device, when it is determined that the language of the text is not the same as the language set in the device.

According to an embodiment of the present disclosure, it is possible to improve the accuracy of interaction between a user and a device in a vehicle by updating the language of text to the same language as the language set in the device and providing the text to the user.

According to an embodiment of the present disclosure, it is possible to enhance the convenience of the user by updating the language of text to the same language as the language set in the device and providing the text to the user.

The technical effects of the present disclosure are not limited to the technical effects described above. Other technical effects not mentioned herein may be more clearly understood by those having ordinary skill in the art to which the present disclosure pertains from the description below.

### BRIEF DESCRIPTION OF THE DRAWINGS

FIG. 1 is a schematic diagram illustrating a configuration of an apparatus for providing an interface in the same language as a language set in a user device, according to an embodiment of the present disclosure.

FIG. 2 is a flowchart schematically illustrating a method of providing an interface in the same language as a language set in a user device, according to an embodiment of the present disclosure.

FIG. 3A is a diagram illustrating an example of an interface provided to a user before user utterance is made, according to an embodiment of the present disclosure.

FIG. 3B is a diagram illustrating an example of an interface provided to a user when it is determined that there is no command corresponding to user utterance, according to an embodiment of the present disclosure.

FIG. 3C is a diagram illustrating an example of an interface provided to a user when it is determined that a language of text is not the same as a language set in a device, according to an embodiment of the present disclosure.

FIG. 4 is a diagram schematically illustrating a configuration of an example computing device that may be used to implement an apparatus and a method described in the present disclosure, according to an embodiment of the present disclosure.

### DETAILED DESCRIPTION

Hereinafter, embodiments of the present disclosure are described in detail with reference to the accompanying drawings. In the accompanying drawings, like reference numerals designate like elements even when the elements are shown in different drawings. Further, in the following description, where it was determined that a detailed description of a known function or configuration may obcure the gyst of the present disclosure, the detailed description thereof has been omitted for the purpose of clarity and for brevity.

Additionally, various terms such as first, second, A, B, (a), (b), etc., are used solely to differentiate one component from the another componenet. Such terms not to imply or suggest the substances, order, or sequence of the components. Throughout this specification, when a part ‘includes’or ‘comprises’a component, the part is meant to further include other components, not to exclude other compoenets unless specifically stated to the contrary. The terms such as ‘unit’, ‘module’, and the like refer to one or more units for processing at least one function or operation, which may be implemented by hardware, software, or a combination thereof.

When a component, device, element, or the like of the present disclosure is described as having a purpose or performing an operation, function, or the like, the component, device, or element should be considered herein as being “configured to” meet that purpose or perform that operation or function.

The following detailed description, together with the accompanying drawings, is intended to describe illustrative embodiments of the present disclosure, and is not intended to represent the only embodiments in which the present disclosure may be practiced.

For the purpose of illustration, the following detailed description assumes that the user speaks Korean and that the language set in the user's device is Korean.

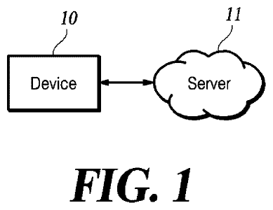

FIG. 1 is a schematic diagram of a configuration of an apparatus for providing an interface in the same language as a language set in a user device, according to an embodiment of the present disclosure.

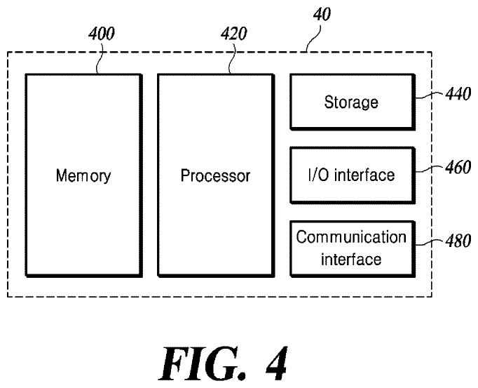

Referring to FIG. 1, the apparatus for providing an interface in the same language as a language set in a user device according to an embodiment of the present disclosure may be implemented using a device 10, a server 11, or a combination thereof. The device 10 may refer to an in-vehicle device. The in-vehicle device may be a computing device mounted inside a vehicle. The server 11 may be one of a cloud server, a web server, a database server, and an application server, or a combination thereof. The device 10 and/or the server 11 may correspond to the computing device described in more detail below with reference to FIG. 4. The device 10 and the server 11 may communicate with each other. Hereinafter, in describing methods for providing an interface in the same language as a language set in a user device according to embodiments of the present disclosure, apparatuses used to perform the methods are described as being divided into a terminal (10) and a server (11) for convenience, but the present disclosure is not limited thereto. For example, a part of the method described as being performed using the device 10 may be performed using the server 11, and a part of the method described as being performed using the server 11 may be performed using the device 10.

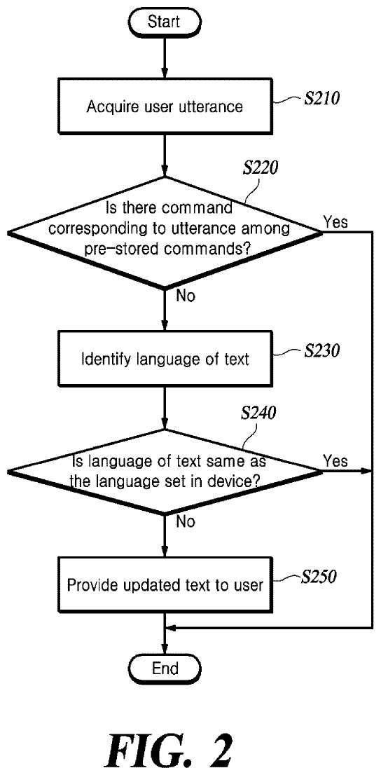

FIG. 2 is a flowchart schematically illustrating a method of providing an interface in the same language as a language set in a user device, according to an embodiment of the present disclosure.

Referring to FIG. 2, in a process or oeration S210, the device 10 acquires a user utterance. The user utterance generally means speech. The device 10 may perform preprocessing and speech recognition on the user utterance. Preprocessing may be a process of extracting features from the user utterance and converting the speech into text. A preprocessing result may be a spectrogram. Speech recognition may be a process of converting the user utterance into text. If the user utterance is speech, speech recognition may be a process of converting the speech into text. An acoustic model (AM), a language model (LM), and/or a lexicon may be used for speech recognition.

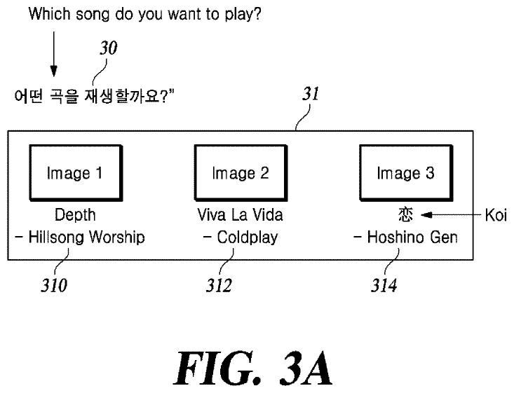

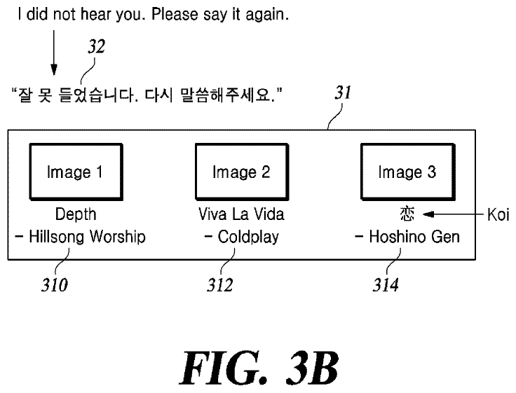

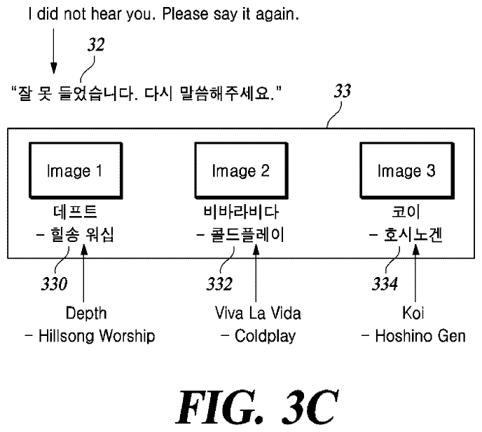

FIG. 3A is a diagram illustrating an example of an interface provided to a user before a user utterance is made, according to an embodiment of the present disclosure.

The user utterance may be a user's reply to text provided to the user by the device 10. The text may be provided by AVNT (Audio, Video, Navigation, and Telematics) in a vehicle in which the user is riding. The AVNT may be provided using the device 10. Referring to FIG. 3A, the device 10 may ask the user a question 30 using an audio system included in the AVNT. The device 10 may also provide a screen 31 related to the question 30 to the user using an in-vehicle display included in the AVNT. As illustrated in FIG. 3A, the question 30 may be, for example, “Which song do you want to play? ” in Korean. The screen 31 related to the question 30 may include the titles of one or more songs, the names of singers, and an image of an album containing the songs. For example, the screen 31 related to the question 30 may include the titles of three songs, the names of singers, and image(s) of album(s) containing the songs.

In the case of FIG. 3A, the text provided to the user may be the question 30, the titles, and singer names 310, 312, and 314 of three songs, included in the screen 31 related to the question 30. In the present disclosure, the term “text” is used as an inclusive concept regardless of the form in which it is provided to the user. For example, text may be provided to the user by speech or may be provided using an in-vehicle display. In an example, the text provided to the user may be the question 30 of “Which song do you want to play? ” in Korean, the title and singer name 310 of song 1, “Depth” and “Hillsong Worship”, the title and singer name 312 of song 2, “Viva La Vida” and “Coldplay”, and the title and singer name 314 of song 3, “ [symbol] ” and “Hoshino Gen”.

In the case of FIG. 3A, the user's reply may be the title of song 1. For example, the user's reply may be “depth”. The user's reply may be a user utterance. The device 10 may obtain the utterance, “depth”, generated by the user for the text 30, 310, 312, and 314 provided to the user.

Referring again to FIG. 2, in a process or operation S220, the device 10 and/or the server 11 determine whether there is a command corresponding to the user utterance among pre-stored commands. The process or operation S220 in which the device 10 and/or the server 11 determine whether there is a command corresponding to the user utterance among the pre-stored commands may include processes or operations according to embodiments described below. However, the present disclosure is not limited to the embodiments descrined below.

FIG. 3B is a diagram illustrating an example of an interface provided to the user when it is determined that there is no command corresponding to the user utterance, according to an embodiment of the present disclosure.

According to a first embodiment, the device 10 determines whether there is a command corresponding to the user utterance among commands pre-stored in the device 10. When it is determined that there is no command corresponding to the user utterance among the commands pre-stored in the device 10, the server 11 obtains the user utterance from the device 10 (e.g., the device 10 transmits the user utterance ot the server 11). The server 11 determines whether there is a command corresponding to the user utterance among commands pre-stored in the server 11. The commands pre-stored in the server 11 i) may include commands different from the commands pre-stored in the device 10 only or ii) may include all commands pre-stored in the device 10 and further include commands different from the commands pre-stored in the device 10. When it is determined that there is no command corresponding to the user utterance among the commands pre-stored in the server 11, the device 10 may request a reply to the text that has been provided to the user in advance by using an audio system included in the AVNT. Referring to FIG. 3B, the request 32 may be “I did not hear you. Please say it again” in Korean. In the case of the first embodiment, when a user utterance is made in response to the request 32 and the user utterance is re-acquired, an operation S230 may be performed.

According to a second embodiment, when a user utterance is made in response to the request 32 and the user utterance is re-acquired, the process or operation included in the first embodiment is repeated once more instead of performing the operation S230. In other words, the second embodiment may further include, compared to the first embodiment, a process or operation of determining whether there is a command corresponding to the re-acquired user utterance among the commands pre-stored in the device 10, a process or operation of determining whether there is a command corresponding to the re-acquired user utterance among the commands pre-stored in the server 11 if it is determined that there is no command corresponding to the re-acquired user utterance among the commands pre-stored in the device 10, and a process or operation of requesting a reply to text that has been previously provided to the user if it is determined that there is no command corresponding to the re-acquired user utterance among the commands pre-stored in the server 11. In order to distinguish the request in the second embodiment from the request in the first embodiment, the request in the second embodiment may be represented as a second request, and the request in the first embodiment may be represented as a first request. Thus, the first embodiment includes only the first request, but the second embodiment may include the first request and the second request. The content of the second request may be the same as the content of the first request. For example, like the first request, the second request may be “I did not hear you. Please say it again” in Korean. In this context, both the first request and the second request may be referred to as the request 32 in FIG. 3B. In the case of the second embodiment, when a user utterance for the second request is made and the user utterance is re-acquired, the process or operation S230 may be performed.

If none of the commands pre-stored in the device 10 and the server 11 correspond to the re-acquired user utterance, the server 11 may perform the process or peration S230 to identify the language of the text provided to the user. The re-acquired user utterance may be a user utterance for the most recent request. For example, the re-acquired user utterance may be the user utterance for the first request in the first embodiment, and the user utterance for the second request in the second embodiment. Since a technology for identifying a language can be easily performed by those having ordinary skill in the art, a detailed description thereof has been omitted.

In order to identify the language of the text, the server 11 may extract character data from an image included in visual information provided to the user using an in-vehicle display included in the AVNT. For example, in the case of FIG. 3A, since the question 30 is data generated by the device 10 or server 11 according to an embodiment of the present disclosure, the process of extracting character data from an image may be unnecessary. On the other hand, since the song titles and singer names 310, 312, and 314 are data created by a third party, the process of extracting character data from an image may be necessary. Since a technology for extracting character data from an image, such as optical character recognition (OCR), can be easily performed by those having ordinary skill in the art, a detailed description thereof has been omitted.

In a process or operation S240, the server 11 determines whether the language of the text provided to the user is the same as the language set in the device 10. The text provided to the user may include a question 30, titles and singer names 310, 312, and 314, and a request 32. The request 32 may include not only the most recent request but also all requests made up to now. For example, in the case of the first embodiment, the text provided to the user may include the question 30, titles and singer names 310, 312, and 314, and a first request. In the case of the second embodiment, the text provided to the user may include the question 30, titles and singer names 310, 312, and 314, a first request, and a second request.

The language set in the device 10 may be in the same language as the language set as the default language of an interface provided to the user. In the case of FIG. 3B, the language set in the device 10 may be Korean. The language of the text provided to the user may be Korean for the question 30, English for the title and singer name 310 of song 1, English for the title and singer name 312 of song 2, Japanese and English for the title and singer name 314 of song 3, and Korean for the request 32. Accordingly, the server 11 may determine that, in the text provided to the user, i) the language of the question 30 and the request 32 is the same as the language set in the device and ii) the language of the titles and singer names 310, 312, and 314 of songs 1 to 3 is not the same as the language set in the device.

If the device 10 determines that the language of the text provided to the user is not the same as the language set in the device 10, the device 10 updates the text provided to the user to text in the same language as the language set in the device and provides the updated text to the user in a process or operation S250. The device 10 may use a lexicon in order to update the text provided to the user such that the language of the text is the same as the language set in the device 10.

A lexicon is a dictionary representing a relationship between a grapheme and a phoneme. A lexicon may be present for each language for a grapheme. For example, an English lexicon may contain English graphemes and phonemes, where the graphemes and phonemes are matched with each other. An English grapheme may be “Depth” and a corresponding phoneme may be “depθ”. A Korean lexicon may contain Korean graphemes and phonemes, where the graphemes and phonemes are matched with each other. A Korean grapheme may be “ [symbol] ”, and a corresponding phoneme may be “depθ”.

The device 10 may convert the language of text into a language set in the device 10 based on one or more lexicons. The one or more lexicons may include a first lexicon and a second lexicon. A process or operation of converting the language of text into a language set in the device based on one or more lexicons may include i) a process or operation of obtaining phonemes matching graphemes by using the first lexicon including graphemes for the language of the text and ii) a process or operation of obtaining graphemes matching the acquired phonemes by using the second lexicon including graphemes for the language set in the device 10.

In the case of FIG. 3B, the device 10 obtains phonemes for “Depth” and “Hillsong Worship” using an English lexicon since the title and singer name 310 of song 1 are represented as graphemes in English. Thereafter, the device 10 obtains graphemes “ [symbol] ” and “ [symbol] ” for the obtained phonemes using a Korean lexicon since the language set in the device 10 is Korean.

The device 10 obtains phonemes for “Viva La Vida” and “Coldplay” using the English lexicon since the title and singer name 312 of song 2 are represented as graphemes in English. Thereafter, the device 10 obtains graphemes “ [symbol] ” and “ [symbol] ” for the obtained phonemes using the Korean lexicon since the language set in the device 10 is Korean.

In the case of the title and singer name 314 of song 3, the title is represented as a grapheme in Japanese and the singer name is represented as graphemes in English. Thus the device 10 obtains a phoneme for “ [symbol] ” using a Japanese lexicon and obtains phonemes for “Hoshino Gen” using the English lexicon. Thereafter, since the language set in the device is Korean, the device 10 obtains graphemes “ [symbol] ” and “ [symbol] ” for the obtained phonemes using the Korean lexicon.

FIG. 3C is a diagram illustrating an example of an interface provided to a user when it is determined that the language of text is not the same as a language set in the device, according to an embodiment of the present disclosure.

The device 10 updates the text on ased on phonemes obtained using the lexicon and provides the updated text to the user again. The language of the updated text may be the same as the language set in the device 10. The updated text may be provided using the AVNT in the vehicle in which the user is riding. The AVNT may be provided using the device 10. Referring to FIG. 3C, updated text 330, 332, and 334 provided by the device 10 to the user is illustrated. In contrast to FIG. 3B, the title and singer name 310 of song 1 expressed in English have been updated to the title and singer name 330 of song 1 expressed in Korean, which is the language set in the device 10. The title and singer name 312 of song 2 expressed in English have been updated to the title and singer name 332 of song 2 expressed in Korean, which is the language set in the device 10. The title and singer name 314 of song 3 expressed in Japanese and English have been updated to the title and singer name 334 of song 3 expressed in Korean, which is the language set in the device 10. The device 10 and the server 11 according to an embodiment of the present disclosure may thus provide an interface in the same language as the language set in the user device 10 by converting the language of text provided to the user, which is expressed in English, Japanese, etc., into Korean, which is the language set in the device 10, and providing the text the user.

FIG. 4 is a schematic diagram illustrating a configuration of an example computing device that may be used to implement the apparatus and method described in the present disclosure.

The computing device 40 may include some or all of a memory 400, a processor 420, a storage 440, an input/output interface 460, and a communication interface 480. The computing device 40 may be a stationary computing device, such as a desktop computer or a server, for example. As another example, the computing device 40 may be a mobile computing device, such as a laptop computer or a smartphone. The computing device 40 may include any specialized hardware accelerator capable of efficiently processing operations for an artificial intelligence model. For example, the computing device 40 may include a graphic processing unit (GPU), a tensor processing unit (TPU), and/or a neural processing unit (NPU).

The memory 400 may store a program that causes the processor 420 to perform a method or operation according to various embodiments of the present disclosure. For example, the program may include a plurality of instructions executable by the processor 420, and the above-described method or operation may be performed by the processor 420 executing the plurality of instructions. The memory 400 may be a single memory or a plurality of memories. Thus, information necessary to perform the method or operation according to various embodiments of the present disclosure may be stored in a single memory or may be divided and stored in a plurality of memories. When the memory 400 is composed of a plurality of memories, the plurality of memories may be physically separated. The memory 400 may include at least one of a volatile memory and/or a nonvolatile memory. The volatile memory may include a static random access memory (SRAM), a dynamic random access memory (DRAM), and/or the like. The nonvolatile memory may includes a flash memory and/or the like.

The processor 420 may include at least one core capable of executing at least one instruction. The processor 420 may execute instructions stored in the memory 400. The processor 420 may be a single processor or a plurality of processors.

The storage 440 maintains stored data even when power supplied to the computing device 40 is cut off. For example, the storage 440 may include a nonvolatile memory, or may include storage media such as a magnetic tape, an optical disk, or a magnetic disk. A program stored in the storage 440 may be loaded into the memory 400 before being executed by the processor 420. The storage 440 may store a file written in a programming language. A program generated from a file by a compiler or the like may be loaded into the memory 400. The storage 440 may store data to be processed by the processor 420 and/or data processed by the processor 420.

The input/output interface 460 may provide an interface with an input device such as a keyboard or a mouse and/or an output device such as a display device or a printer. The user may trigger execution of a program by the processor 420 through the input device and/or check a processing result of the processor 420 through the output device.

The communication interface 480 may provide access to an external network. The computing device 40 may communicate with other devices through the communication interface 480.

Each element of the apparatus or method in accordance with the embodiments of the present disclosure may be implemented in hardware or software, or a combination of hardware and software. The functions of the respective elements may be implemented in software, and a microprocessor may execute the software functions corresponding to the respective elements.

Various embodiments of systems and techniques described herein may be realized with digital electronic circuits, integrated circuits, field programmable gate arrays (FPGAs), application specific integrated circuits (ASICs), computer hardware, firmware, software, and/or combinations thereof. The various embodiments may include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code may be stored and executed in a distributive manner.

Although operations are illustrated in the flowcharts/timing charts in this specification as being sequentially performed, this is merely an illustrative description of the technical idea of an embodiment of the present disclosure. In other words, those having ordinary skill in the art to which the present disclosure pertains should understand that various modifications and changes may be made without departing from essential features of the present disclosure. For example, the sequence illustrated in the flowcharts/timing charts may be changed and/or one or more of the operations may be performed in parallel. Thus, flowcharts/timing charts are not limited to the temporal order.

Although example embodiments of the present disclosure have been described for illustrative purposes, those having ordinary skill in the art should understand that various modifications, additions, and substitutions are possible, without departing from the idea and scope of the present disclosure. Therefore, illuarative embodiments of the present disclosure have been described for the sake of brevity and clarity. The scope of the present embodiments is not limited by the illustrations. Accordingly, one of ordinary skill would understand that the scope of the present disclosure is not to be limited by the above explicitly described embodiments but by the claims and equivalents thereof.

What is claimed is:

1. A computer-implemented method of providing an interface in a same language as a language set in a device of a user, the computer-implemented method comprising:
obtaining an utterance generated by the user for text provided to the user using the device;
determining whether there is a command corresponding to the utterance among pre-stored commands;
determining whether a language of the text is the same as the language set in the device when it is determined that there is no command corresponding to the utterance among the pre-stored commands; and
providing updated text to the user when it is determined that the language of the text is not the same as the language set in the device, wherein the updated text is in the same language as the language set in the device.

2. The computer-implemented method of claim 1, further comprising identifying the language of the text.

3. The computer-implemented method of claim 2, wherein identifying the language of the text inlcudes extracting character data from an image included in visual information provided to the user using an in-vehicle display.

4. The computer-implemented method of claim 1, wherein determining whether there is a command corresponding to the utterance among the pre-stored commands includes determining that there is no command corresponding to the utterance when one or both of i) a first criterion determined based on whether there is a command corresponding to the utterance among commands pre-stored in the device is not satisfied or ii) a second criterion determined based on whether there is a command corresponding to the utterance among commands pre-stored in a server connected to the device is not satisfied.

5. The computer-implemented method of claim 4, wherein determining whether there is a command corresponding to the utterance among the pre-stored commands includes:
determining whether the first criterion is satisfied; and
determining whether the second criterion is satisfied when the first criterion is not satisfied.

6. The computer-implemented method of claim 1, wherein providing the updated text to the user includes converting the language of the text into the language set in the device based on one or more lexicons.

7. The computer-implemented method of claim 6, wherein:
the one or more lexicons include a first lexicon including relationships between graphemes and phonemes for the language of the text and a second lexicon including relationships between graphemes and phonemes for the language set in the device; and
converting the language of the text into the language set in the device based on one or more lexicons includes
obtaining phonemes of the text based on the text expressed as graphemes for the language of the text by using the first lexicon, and
obtaining graphemes for the language set in the device based on the phonemes by using the second lexicon.

8. An apparatus for providing an interface in a same language as a language set in a device of a user, the apparatus comprising:
at least one memory storing instructions; and
at least one processor,
wherein the at least one processor is configured to execute the instructions to
obtain an utterance generated by the user for text provided to the user using the device,
determine whether there is a command corresponding to the utterance among pre-stored commands,
determine whether a language of the text is the same as the language set in the device when it is determined that there is no command corresponding to the utterance among pre-stored commands, and
provide updated text to the user when it is determined that the language of the text is not the same as the language set in the device, wherein the updated text is in the same language as the language set in the device.

9. The apparatus of claim 8, wherein the at least one processor is further configured to execute the instructions to identify the language of the text.

10. The apparatus of claim 9, wherein the at least one processor is configured to execute the instructions to identify the language of the text at least by extracting character data from an image included in visual information provided to the user by using an in-vehicle display.

11. The apparatus of claim 8, wherein the at least one processor is configured to execute the instructions to determine that there is no command corresponding to the utterance when one or both of i) a first criterion determined based on whether there is a command corresponding to the utterance among commands pre-stored in the device is not satified or ii) a second criterion determined based on whether there is a command corresponding to the utterance among commands pre-stored in a server connected to the device is not satisfied.

12. The apparatus of claim 11, wherein the at least one processor is configured to execute the instructions to determine whether there is a command corresponding to the utterance among the pre-stored commands at least by:
determining whether the first criterion is satisfied; and
determining whether the second criterion is satisfied when the first criterion is not satisfied.

13. The apparatus of claim 8, wherein the at least one processor is configured to execute the instructions to provide the updated text to the user at least by converting the language of the text into the language set in the device based on one or more lexicons.

14. The apparatus of claim 13, wherein:
the one or more lexicons include a first lexicon including relationships between graphemes and phonemes for the language of the text and a second lexicon including relationships between graphemes and phonemes for the language set in the device; and
the at least one processor is configured to execute the instructions to convert the language of the text into the language set in the device at least by
obtaining phonemes of the text based on the text expressed as graphemes for the language of the text by using the first lexicon, and
obtaining graphemes for the language set in the device based on the phonemes by using the second lexicon.
